(19) United States
(12) Patent Application Publication
(10) Pub. No.: US 2010/0054621 A1
(43) Pub. Date: Mar. 4, 2010

(54) DUAL LOOKUP TABLE DESIGN FOR EDGE-DIRECTED IMAGE SCALING

(75) Inventors: Yingyong Qi, San Diego, CA (US); King-Chung Lai, San Diego, CA (US); Millie Li, San Diego, CA (US); Chia-Yuan Teng, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/198,404

(22) Filed: Aug. 26, 2008

(51) Int. Cl. G06K 9/40

(52) U.S. Cl. 382/260

(57) ABSTRACT

In general, the disclosure describes various techniques for providing edge-directed scaling filters that may be used to scale image data. An example device includes a storage medium configured to store a first lookup table and a second lookup table, and one or more processors configured to obtain one or more gradient values that each indicates a gradient between values of at least two pixels in a source image. The one or more processors are also configured to generate one or more inverse gradient values from a first lookup table based on the gradient values, and to generate one or more edge-directed scaling filter coefficients from a second lookup table based on the inverse gradient values. The one or more processors may be further configured to generate an edge-directed filter based on the coefficients, and to apply the filter to the at least two pixels to generate an interpolated pixel.

### TECHNICAL FIELD

This disclosure relates to techniques for scaling image/video data within a graphics/video processing system.

### BACKGROUND

Display devices are capable of displaying a variety of different types of image data, including image data captured by digital video or still photo cameras, image data obtained from video or still photo archives, image data produced by software applications, or even image data obtained from broadcast or streaming media, to name just a few examples. A display device may be integrated with, coupled to, or otherwise associated with a variety of devices, such as desktop or laptop computers, computer workstations, mobile devices such as personal digital assistants (PDAs) or mobile telephones, wireless communication devices, multi-media devices, cameras, or dedicated viewing stations such as televisions. A display device may comprise a liquid crystal display (LCD), a cathode ray tube (CRT) display, a plasma display, a projection display, or the like.

In many cases, a display device may have an inherent maximum resolution that is limited by the number of pixels of image data capable of being displayed. In general, display devices may produce a range of image resolutions at or below the inherent maximum resolution. If the image data or information, however, defines values for fewer than all of the display pixels, the device may scale the image data upward to a larger resolution. For example, a display device may produce additional pixels by interpolation to scale the image data to a larger format. As display devices become larger, image scaling becomes increasingly important. For mobile applications, even though users may desire larger displays, channel limitations tend to reduce the amount of image data that can be transmitted to a mobile device, resulting in smaller format images. Hence, image upscaling may be desirable for certain mobile applications.

Many techniques currently exist to achieve image upscaling or downscaling. Common interpolation techniques include bilinear interpolation, bicubic interpolation, cubic spline interpolation, and edge directed interpolation (EDI).

### SUMMARY

In general, this disclosure is directed to techniques for providing a dual lookup table design for edge-directed image scaling, such as upscaling or downscaling. This design provides support for gradient-based edge-directed algorithms, such as interpolation or decimation algorithms. In one form of interpolation algorithm, coefficients of an interpolation filter are adaptive to local gradient levels of image data, and may be stored in one of the lookup tables. This interpolation algorithm may produce sharper scaled images as compared to bicubic or cubic spline interpolation algorithms. Furthermore, the fidelity of the interpolated image, with respect to the original high-resolution image, may be enhanced. In some aspects, an edge-directed scaling method may involve certain complex operations, such as pixel-wise square-root and/or inverse operations. However, a dual lookup table design may support low complexity, memory-efficient implementations of edge-directed scaling.

In one aspect, the disclosure provides a method comprising obtaining one or more gradient values that each indicates a gradient between values of at least two pixels in a source image, generating one or more inverse gradient values from a first lookup table based on the one or more gradient values, and generating one or more edge-directed scaling filter coefficients from a second lookup table based on the one or more inverse gradient values. The method may further comprise generating an edge-directed scaling filter based on the edge-directed scaling filter coefficients, and applying the edge-directed scaling filter to the at least two pixels to generate an interpolated pixel.

In another aspect, the disclosure provides a device comprising a storage medium configured to store a first lookup table and a second lookup table, and one or more processors configured to obtain one or more gradient values that each indicates a gradient between values of at least two pixels in a source image. The one or more processors are also configured to generate one or more inverse gradient values from a first lookup table based on the one or more gradient values, and to generate one or more edge-directed scaling filter coefficients from a second lookup table based on the one or more inverse gradient values. The one or more processors may be further configured to generate an edge-directed scaling filter based on the coefficients, and to apply the filter to the at least two pixels to generate an interpolated pixel.

In another aspect, the disclosure is directed to a computer-readable medium containing instructions. The instructions cause a programmable processor to obtain one or more gradient values that each indicates a gradient between values of at least two pixels in a source image, generate one or more inverse gradient values from a first lookup table based on the one or more gradient values, and generate one or more edge-directed scaling filter coefficients from a second lookup table based on the one or more inverse gradient values. The computer-readable medium may contain further instructions that cause the programmable processor to generate an edge-directed scaling filter based on the edge-directed scaling filter coefficients, and apply the edge-directed scaling filter to the at least two pixels to generate an interpolated pixel.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a graphics device that may be used to perform scaling operations on image data, according to one aspect of the disclosure.

FIG. 2 is a graph diagram illustrating example pixel locations and gradient value measurements for image data, according to one aspect of the disclosure.

FIG. 3A is a block diagram illustrating various modules of a graphics device that may be used to perform scaling operations on image data, according to one aspect of the disclosure.

FIG. 3B is a block diagram illustrating additional details of certain modules shown in FIG. 3A, according to one aspect of the disclosure.

FIG. 3C is a block diagram illustrating an example of entries within a first lookup table that may be part of the device shown in FIG. 3A.

FIG. 3D is a block diagram illustrating an example of an address calculation block and a second lookup table that may be part of the graphics device shown in FIG. 3A.

FIG. 4 is a block diagram illustrating an example of entries that may be included within a second lookup table, such as the second lookup table shown in FIG. 3D.

FIG. 5 is a graph diagram illustrating gradient and inverse gradient values, according to one aspect of the disclosure.

FIG. 6 is a flow diagram illustrating a method that may be performed by a graphics device to generate scaling filter coefficients for pixel interpolation, according to one aspect of the disclosure.

FIG. 7 is a flow diagram illustrating a method that may be performed by a graphics device to generate a plurality of interpolated pixels, according to one aspect of the disclosure.

### DETAILED DESCRIPTION

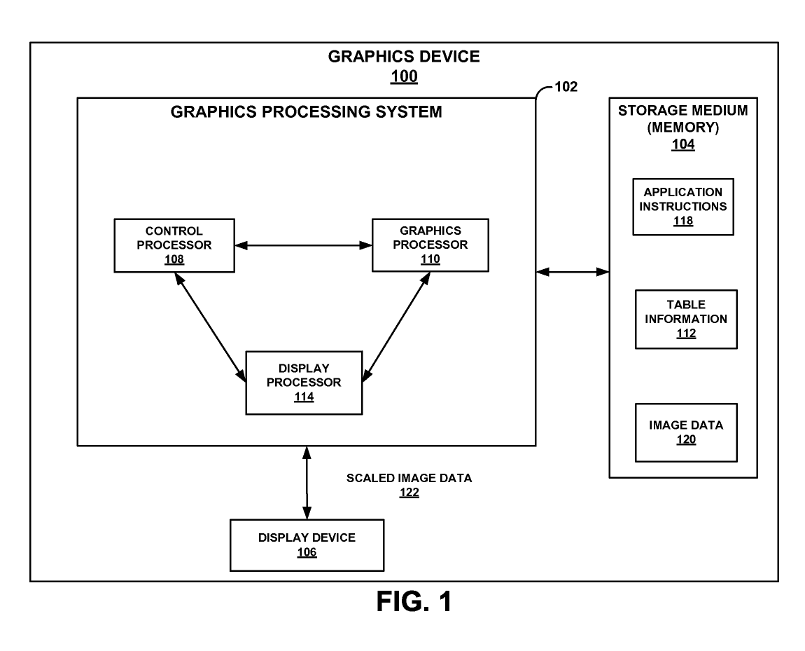

FIG. 1 is a block diagram illustrating a graphics device 100 that may be used to perform scaling operations on image data, according to one aspect of the disclosure. Graphics device 100 may be a stand-alone device or may be part of a larger system. For example, graphics device 100 may comprise a wireless communication device (such as a wireless mobile handset), or may be part of a digital camera, video camera, digital multimedia player, personal digital assistant (PDA), video game console, other video device, or a dedicated viewing station (such as a television). Graphics device 100 may also comprise a personal computer (such as an ultra-mobile personal computer) or a laptop device. Graphics device 100 may also be included in one or more integrated circuits, or chips, which may be used in some or all of the devices described above.

In some cases, graphics device 100 may be capable of executing various applications, such as graphics applications, video applications, audio applications, and/or other multi-media applications. For example, graphics device 100 may be used for graphics applications, video game applications, video playback applications, digital camera applications, instant messaging applications, video teleconferencing applications, mobile applications, or video streaming applications.

Graphics device 100 may be capable of processing a variety of different data types and formats. For example, graphics device 100 may process still image data, moving image (video) data, or other multi-media data, as will be described in more detail below. The image data may include computer-generated graphics data. In the example of FIG. 1, graphics device 100 includes a graphics processing system 102, storage medium 104 (which comprises memory), and a display device 106. Programmable processors 108, 110, and 114 may be included within graphics processing system 102. Programmable processor 108 is a control, or general-purpose, processor. Programmable processor 110 is a graphics processor, and programmable processor 114 may be a display processor. Control processor 108 may be capable of controlling both graphics processor 110 and display processor 114. Processors 108, 110, and 114 may be scalar or vector processors. In one aspect, graphics device 100 may include other forms of multi-media processors.

In graphics device 100, graphics processing system 102 is coupled both to storage medium 104 and to display device 106. Storage medium 104 may include any permanent or volatile memory that is capable of storing instructions and/or data, such as, for example, synchronous dynamic random access memory (SDRAM), read-only memory (ROM), non-volatile random access memory (NVRAM), embedded dynamic random access memory (eDRAM), static random access memory (SRAM), or flash memory. Display device 106 may be any device capable of displaying image data for display purposes, such as an LCD (liquid crystal display), plasma display device, or other television (TV) display device.

Graphics processor 110 may be a dedicated graphics rendering device utilized to render, manipulate, and display computerized graphics. Graphics processor 110 may implement various complex graphics-related algorithms. For example, the complex algorithms may correspond to representations of two-dimensional or three-dimensional computerized graphics. Graphics processor 110 may implement a number of so-called “primitive” graphics operations, such as forming points, lines, and triangles or other polygon surfaces, to create complex, three-dimensional images on a display, such as display device 106.

Graphics processor 110 may carry out instructions that are stored in storage medium 104. Storage medium 104 is capable of storing application instructions 118 for an application (such as a graphics or video application), table information 112, and image data 120. Application instructions 118 may be loaded from storage medium 104 into graphics processing system 102 for execution. For example, one or more of control processor 108, graphics processor 110, and display processor 114 may execute instructions 118. In one aspect, application instructions 118 may comprise one or more downloadable modules that are downloaded dynamically, over the air, into storage medium 104.

Storage medium 104 further includes image data 120. Image data 120 includes data associated with one or more images, including still or moving images that may be processed within graphics processing system 102 and/or displayed on display device 106. Storage medium 104 also includes table information 112. Table information 112 may contain one or more tables, such as lookup tables, that may be loaded into and used by graphics processing system 102 when processing the image data 120.

For example, display processor 114 may use table information 112 to scale image data 120 for display purposes, as will be described in more detail below. Display processor 114 may, in many cases, either upscale or downscale image data 120 to generate corresponding scaled (such as upscaled or downscaled) image data 122 that is to be displayed on display device 106. In some cases, application instructions 118 may include certain instructions that, when executed by display processor 114, scale image data 120 to generate scaled image data 122.

When generating downscaled image data, display processor 114 may use one or more decimation algorithms or techniques. When generating upscaled image data, display processor 114 may use one or more algorithms or techniques, which may include interpolation. Common interpolation techniques may include bilinear interpolation, bicubic interpolation, cubic spline interpolation, or edge-directed interpolation (EDI). Some techniques, such as NEDI (New Edge-Directed Interpolation [Xin Li, Michael T. Orchard, IEEE Transactions on Image Processing, October 2001]), may require complex calculations that consume an excessive amount of system resources within graphics device 100, especially if graphics device 100 is a small mobile device. Further, some existing interpolation techniques may be unsuitable when image data 120 includes color image information, and these techniques may result in color bleeding or other artifacts.

In one aspect, graphics device 100 is capable of performing gradient-based edge-directed scaling, such as interpolation. A gradient-based edge-directed scaling algorithm may be implemented in one-dimensional or multi-dimensional (e.g., two-dimensional) scenarios. In certain cases, a one-dimensional implementation may be more favorable for hardware implementations in graphics device 100. Two-dimensional scaling may be implemented by two separate one-dimensional scaling processes, according to one aspect of this disclosure. For purposes of illustration only, and without limitation, the remainder of this disclosure assumes a one-dimensional scaling process.

In one aspect, graphics device 100 uses table information 112 to implement a gradient-based edge-directed scaling algorithm with respect to image data 120 and generate scaled image data 122. In this aspect, one or more of processors 108, 110, and 114 may receive one or more gradient values used for scaling of image data 120, each gradient value being associated with at least two pixels of image data 120. Processors 108, 110, and/or 114 may then obtain, as output from a first lookup table, one or more predetermined inverse gradient values by at least using the one or more gradient values as input into the first lookup table, and also obtain, as output from a second lookup table, one or more predetermined edge-directed scaling filter coefficients by at least using the one or more inverse gradient values as input into the second lookup table. Hence, the gradient values form first lookup table indices. The first lookup table maps the gradient values to corresponding predetermined inverse gradient values. The predetermined inverse gradient values then form second lookup table indices. The second lookup tables maps the predetermined inverse gradient values to corresponding, predetermined edge-directed scaling filter coefficients. The first lookup table and the second lookup table may be included within table information 112 and loaded into graphics processing system 102. The use of one or more lookup tables may help avoid various implementation complexities within graphics device 100 that may be associated with edge-directed interpolation.

In a scaling algorithm (such as a gradient-based edge-directed scaling algorithm) that supports arbitrary scaling factors, two major steps are often included: (1) location determination; and (2) the determination of the scaling filter coefficients. In general, location determination refers to determination of a location of a pixel that is to be interpolated as well as the identification of the pixels from the original image that should be involved in the interpolation of this pixel in the scaled image. Determination of scaling filter coefficients generally refers to determination of the filter coefficients that are to be used to form a scaling filter. The formed scaling filter may then be used to interpolate pixels in a scaled image. The details of each step are described below.

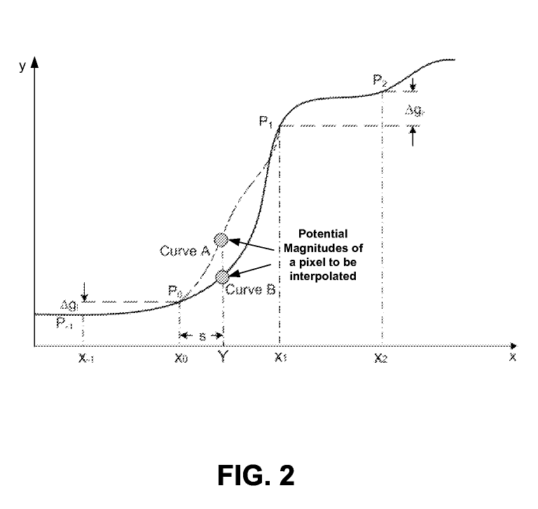

For clarity, the meaning of certain symbols is provided below:
i: pixel location in the scaled data. (i represents integers.)
x(i): original pixel location, prior to scaling, that is related with location i. (This may include fractional values.)
tₓ: initial phase.
P₋₁, P₀, P₁, P₂: Image pixels. Four example pixels are shown, such that two gradient levels are calculated. Each pixel has a distinct location, as shown in FIG. 2.
Δgₗ, Δgᵣ: Gradient levels. Each gradient level is determined from two of the example pixels, as described below.
hₗ, hᵣ: Inverse gradient levels. These inverse gradient levels are determined from the gradient levels, as described below.

With respect to location determination, it is possible to interpolate pixels on a row in the scaled image data 122 based on the pixels on the corresponding row in the original image data 120. For the pixel at location i in the scaled image data 122, its location x(i) in the original image data 120 is determined according to

x(i)=sₓ*i+tₓ (1),

where sₓ is defined as (original image width/scaled image width). The parameter tₓ is a constant which is predefined, naming an initial phase in a fixed-point implementation.

Equation (1) is a graphics-based location mapping. Different scaling factors may correspond to different sₓ values. Arbitrary scaling factors can be supported according to this mapping. The pixels in the original image data 120 that are used for the scaling may be determined by the location x(i). Half of the used pixels may be at one side of the location and the other half may be at the other side of the location.

After locating the pixels in the original image data 120 that are involved in scaling, determination may then be made of the scaling (e.g., upscaling, downscaling) filter coefficients. The scaling filter coefficients are used to form, or generate, a scaling filter that is used to scale the image data. For example, upscaling filter coefficients may be determined in order to complete interpolation, while downscaling coefficients may be determined to complete decimation. In cubic spline interpolation, the coefficients of the scaling filter are typically determined by location x(i), and often by the fractional part of x(i). In the edge-directed scaling algorithm, the coefficients of the cubic spline interpolation filter may, in some cases, be weighted according to local gradient levels. This principle may be illustrated in reference to FIG. 2.

FIG. 2 is a graph diagram illustrating example pixel locations and gradient value measurements for image data, according to one aspect of the disclosure. In FIG. 2, the x-axis represents pixel position (or index) along an axis in one dimension, and the y-axis represents pixel intensity. In FIG. 2, it may be assumed that a pixel to be interpolated is the pixel at location Y, and that the distance between location x0 and Y is s. To pass through the pixels P₋₁, P₀, P₁ and P₂, which are at locations X₋₁, X₀, X₁ and X₂, respectively, two different curves A and B can be drawn (which are shown in FIG. 2). Their values at Y, which are the values B(Y) and A(Y), may be regarded as candidates for the interpolated pixels. In one aspect, an extra constraint can be imposed in order to choose between B(Y) and A(Y). In comparing the gradient levels between P₋₁ and P₀ and between P₁ and P₂, it can be determined that Δgₗ<Δgᵣ, where Δgₗ and Δgᵣ represent gradient levels (and where l=left and r=right).

In this example, the pixels on the left side appear to change more slowly in intensity. Intuitively, if surrounding pixels are changing slowly in magnitude, the pixel to be interpolated may be more predictable. Based upon this observation, heavier weights can be assigned to the pixels that change slowly in magnitude. Thus, if A(Y) and B(Y) are the two candidate curves for interpolation of the pixel at site Y, B(Y) can be selected as the final scaling result.

In one aspect, the concept that heavier weights can be assigned to the slower-changing pixels is implemented through equations (2) to (5). Firstly, with the calculated gradients Δgₗ and Δgᵣ, we may define the inverse gradients as

hₗ=(1+αΔgₗ)^{-1/2} (2)

and

hᵣ=(1+αΔgᵣ)^{-1/2} (3),

where α represents a scalar parameter, which controls the contribution of the gradients Δgₗ and Δgᵣ to the inverse gradients hₗ and hᵣ and eventually to the weighting method of filter coefficients. A larger α value generally leads to a sharper interpolated image. We tune α in a way such that the scaled image is sharp as well as of high fidelity. For example, the scaled image may exhibit high peak-signal-to-noise ratio (PSNR) values. Based on inverse gradients hₗ and hᵣ, a weighting vector may be constructed as

$${G}_{h} = [ \underbrace{1 , … , 1}_{N / 2 - 1} , {h}_{l} , {h}_{r} , \underbrace{1 , … , 1}_{N / 2 - 1} ] , \qquad ( 4 )$$

where N is the number of taps of a scaling filter.

A cubic spline scaling filter may then be weighted by the weighting vector according to

$${A}^{′} = \frac{A ⊗ {G}_{h}}{{AG}_{h}^{T}} , \qquad ( 5 )$$

where \textcircled{x} represents element-wise multiplication of two vectors, and ()^{T} represents the transposing operator. The division operation may normalize the weighted filter coefficients to guarantee that the weighted interpolation filter has a gain of one at frequency zero (direct current, or DC, component). This may be important for a low-pass filter since the energy leakage at the DC component will change the average luminance level of the scaled image.

In one aspect, graphics device 100 (FIG. 1) may utilize a dual lookup table (LUT) hardware implementation, in which some results are predetermined (e.g., pre-calculated) and stored in one or more tables within table information 112. The hardware implementation of a dual LUT approach may be significantly low compared to more complex implementations of arithmetic operations, due to the minimization of complex computations. It is also possible to reduce the memory requirements of a dual LUT implementation while maintaining performance, as will be described in more detail below.

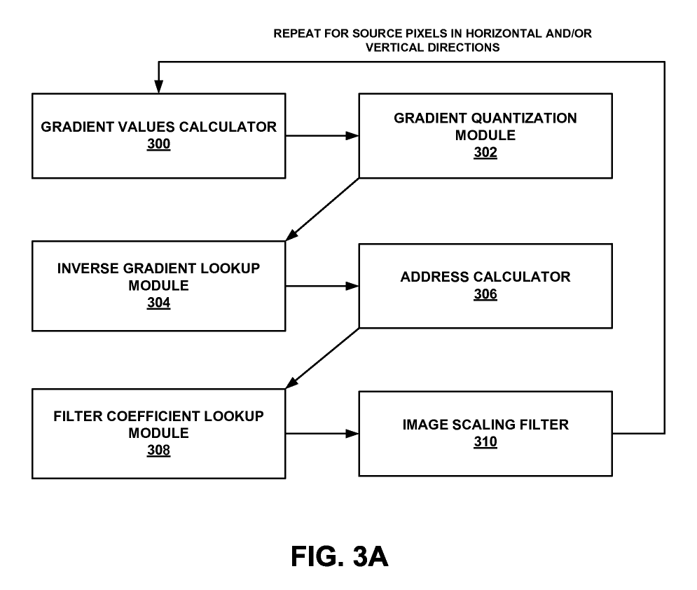

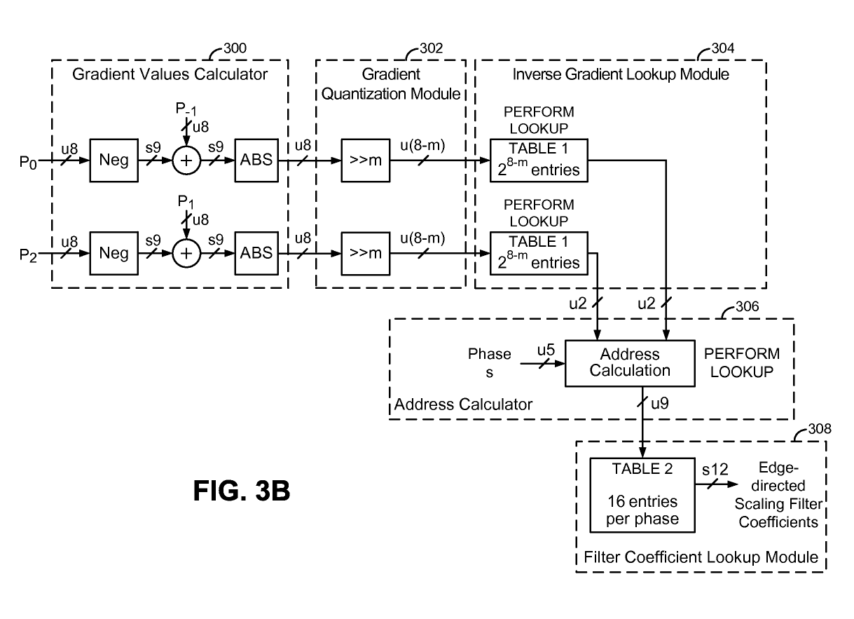

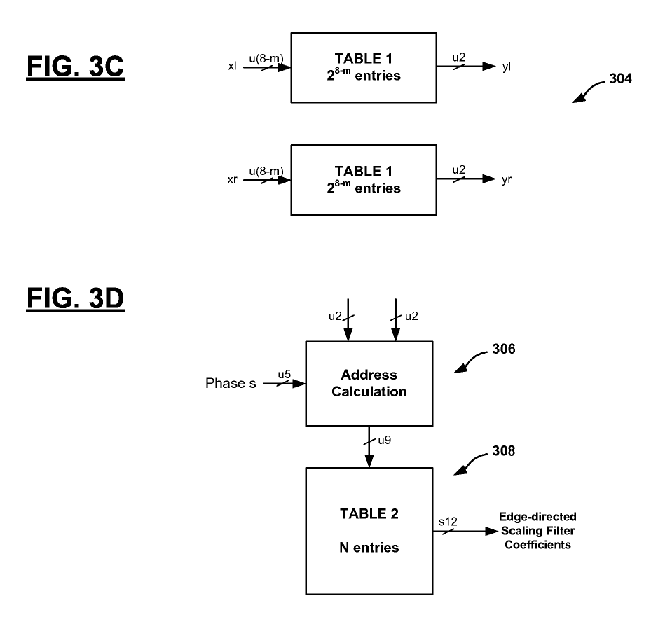

FIG. 3A is a block diagram illustrating various modules that may be used to perform scaling operations on image data 120 shown in FIG. 1, according to one aspect of the disclosure. In this aspect, the various modules 300, 302, 304, 306, 308, 310 comprise programmable features that may be implemented within graphics device 100 shown in FIG. 1. In certain cases, these modules may be implemented by one or more of application instructions 118 executed by one or more of processors 108, 110, and 114, and use of table information 112 and image data, to generate upscaled or downscaled image data 122 for display on display device 106.

As shown in FIG. 3A, these modules include a gradient values calculator 300, a gradient quantization module 302, an inverse gradient lookup module 304, an address calculator 306, a filter coefficient lookup module 308, and an image scaling filter 310. Gradient values calculator 300 calculates gradient values. Gradient quantization module 302 performs non-uniform quantization of the gradient values. Inverse gradient lookup module 304 applies the quantized gradient values as indices to a first lookup table and retrieves corresponding predetermined, quantized inverse gradient values. Address calculator 306 uses the inverse gradient values and phase information to calculate an index address within a second lookup table. Filter coefficient lookup module 308 uses the address to perform a lookup within the second lookup table to retrieve scaling filter coefficients. Image scaling filter 310 uses the coefficients to create a scaling filter that is then used to scale image data, such as image data 120. These modules are now described in further detail below.

Gradient values calculator 300 is capable of calculating one or more gradient values that may be used for scaling purposes. Each gradient value may be calculated based upon the locations of two separate pixels within image data 120.

Gradient quantization module 302 is capable of performing non-uniform quantization of the gradient values calculated by gradient values calculator 300. In one aspect, the non-uniform quantization may comprise a non-linear quantization. As will be described in more detail below, the non-uniform quantization of the gradient values may generate a finite, often small, number of gradient values, which ultimately may help lower or minimize the size of table information 112, since these values may be used to access data within table information 112.

Inverse gradient lookup module 304 is capable of performing a first table lookup of predetermined, quantized inverse gradient values. This first table lookup may be performed on a first table within table information 112. Inverse gradient lookup module 304 may use the quantized gradient values generated by gradient quantization module 302 as an input into this first table to look up the predetermined, quantized inverse gradient values. For example, inverse gradient lookup module 304 may use the quantized gradient values as indices into the first table. The first lookup table maps the input indices provided by the quantized gradient values to predetermined, inverse gradient values. Hence, the first table provides, as output, the corresponding inverse gradient values. These inverse gradient values are predetermined and quantized values that may be stored within the first table. For example, these values may comprise pre-calculated values that are calculated based upon formulas and loaded into the first lookup table. In some cases, the values are pre-loaded into the first lookup table during manufacture of device 100. Each output inverse gradient value is quantized, such that is may have a finite size. The size of the first table may be reduced when the gradient values, which may be used as input into the table, are quantized by gradient quantization module 302.

As noted above, each output inverse gradient value may comprise a pre-calculated value. The first table, or Table One, may be used to substitute for a square-root computation and an inverse computation to provide inverse gradient values as output, as will be described in more detail below. In particular, the mapping between quantized gradient values and inverse gradient values may approximate a square root computation and an inverse computation, such that the inverse gradient values represent the output of such computations when the corresponding quantized gradient value is the input to the computations. For example, the mapping between quantized gradient values and inverse gradient values may approximate the square root and inverse computations shown in equations (2) and (3) above.

Address calculator 306 calculates an address that is used by filter coefficient lookup module 308 to perform a second table lookup of predetermined edge-directed scaling filters. A second lookup table, or Table Two, may be used when performing this second table lookup, and this second table may be stored within table information 112 (FIG. 1). The address calculator 306 uses the output of Table One (the predetermined inverse gradient values) to calculate the address for lookup into Table Two. Address calculator 306 may also use filter phase information, as will be described later, when performing address calculation. Filter coefficient lookup module 308 may then use the calculated address to perform the second table lookup of the predetermined edge-directed scaling filter coefficients. These scaling filter coefficients may include interpolation filter coefficients when the scaling comprises upscaling.

Filter coefficient lookup module 308 is capable of performing a second table lookup of scaling filter coefficients. This second table lookup may be performed on a second table within table information 112. Scaling filter lookup module 304 may use the address from address calculator as an index into this second table to look up the scaling filter coefficients. In some aspects, the lookup operation performed by filter coefficient lookup module 308 may replace the computations in equations (4) and (5) shown above.

Once the predetermined edge-directed scaling filter coefficients have been read out of Table Two, they may be used by image scaling filter 310 to create a scaling filter that may be used to scale the image data 120 and generate an interpolated pixel in scaled image data 122 for display on display device 106. The use of Table One and Table Two may comprise a dual lookup table structure and may decrease the complexity of scaling within graphics device 100. The quantization of various values, such as gradient and/or inverse gradient values, may help minimize the sizes of these tables within table information 112. At the same time, an edge-directed scaling filter implementation may be performed within graphics device 100, which may provide improved scaling performance over certain other techniques, such as a cubic spline technique.

After image scaling filter 310 has used the scaling filter generate an interpolated pixel in scaled image data 122, additional interpolated pixels may be generated by repeating the processes implemented modules 300, 302, 304, 306, 308, and 310 for a plurality of source pixels from source image data 120. Edge-directed scaling filter coefficients may be repeatedly generated and applied to the plurality of source pixels in horizontal and/or vertical directions to generate the interpolated pixels. A “sliding window” may be used to repeatedly apply filter coefficients to source pixels when generating the interpolated pixels, such that one individual filter coefficient is applied to an individual source pixel within the “sliding window”. The “sliding window” may contain multiple source pixels, and may first be moved in a horizontal direction (left-to-right) across pixels within a row of the source image. The “sliding window” may also be moved in a vertical direction (up-down) to slide across the various pixels in the source image. As the “sliding window” moves, generated filter coefficients may be applied to the source pixels within the “sliding window”. In such fashion, the entire source image may be scaled by generating a plurality of interpolated pixels for a scaled image.

FIG. 3B is a block diagram illustrating additional details of modules 300, 302, 304, 306, and 308 shown in FIG. 3A, according to one exemplary aspect of the disclosure. In this aspect, it is assumed that an upscaling operation is being performed, such that Table Two contains interpolation filter coefficients. However, the techniques described in this disclosure also may be readily applied to downscaling operations. As shown in the example of FIG. 3B, gradient values calculator 300 includes subtraction and absolute value operations. Example pixels P₋₁, P₀, P₁, and P₂ are shown, and each pixel is represented by eight unsigned bits (“u8”), which represent an intensity level of the respective pixel. These pixels are assumed to be spatially ordered along a horizontal or vertical line within an image, e.g., as shown in FIG. 2 (where X₋₁ is the location of P₋₁, X₀ is the location of P₀, X₁ is the location of P₁, and X₂ is the location of P₂). Thus, as shown in FIG. 3B, gradient values calculator 300 calculates a gradient value for two adjacent pixels according to this assumed ordering. For example, a gradient value is calculated for pixels P₋₁ and P₀ (which are located to the left of the pixel to be interpolated at location Y, FIG. 2, in the upscaled image), and another gradient value is calculated for pixels P₁ and P₂ (which are located to the right of the pixel to be interpolated at location Y in the upscaled image).

Gradient values calculator 300 first performs a subtraction operation for two adjacent pixels, and then performs an absolute-value operation. In the example of FIG. 3B, P₀ is subtracted from P₋₁ by taking the negative value (“Neg”) of P₀ and then adding this negative value to P₋₁. The negative value of P₀ is represented as a nine-bit signed value (“s9”). In addition, the result of the subtraction is a nine-bit signed valued (“s9”). An absolute-value operation (“ABS”) is then performed to generate an unsigned, eight-bit gradient value with respect to P₋₁ and P₀. Similarly, an unsigned, eight-bit gradient value is calculated for P₁ and P₂ by calculator 300. In general, the gradient value represents a change in pixel intensity between two adjacent pixels.

Gradient quantization module 302 then performs non-uniform quantization of the gradient values. In the example of FIG. 3B, gradient quantization module 302 achieves this quantization by bit shifting the unsigned, eight-bit gradient values to the right by “m” bits (“>>m”). Thus, with respect to pixels P₋₁ and P₀, module 302 generates a quantized gradient value comprising an unsigned value having (8-m) bits. In one example, m=2, such that module 302 generates an unsigned, six-bit gradient value. Similarly, module 302 generates a quantized gradient value comprising an unsigned value of (8-m) bits for pixels P₁ and P₂. Various different values of “m” may be selected to affect the type or level of quantization of the gradient values. A high value of “m” may increase the level of quantization, but may potentially affect scaling performance. A low value of “m” may decrease the level of quantization. As noted above, in one scenario, a value of m=2 may be selected.

Referring again to FIG. 3B, inverse gradient lookup module 304 performs a lookup in Table One of predetermined, quantized inverse gradient values. Inverse gradient lookup module 304 uses the quantized gradient values as input when performing the lookup. In this example, each quantized gradient value is an unsigned value comprising (8-m) bits, and Table One may include 2^{8-m} entries. Thus, in one aspect, the size of Table One may be decreased through quantization of the input gradient values. In the example of FIG. 3B, each quantized gradient value within Table One maps to a predetermined inverse gradient value. This inverse gradient value may comprise a quantized value from a finite number of selectable values (based upon the input gradient values used for the lookup operation within Table One). In the example of FIG. 3B, each inverse gradient value comprises an unsigned, two-bit value (“u2”).

Address calculator 306 calculates a lookup address that may be used by filter coefficient lookup module 308 to perform a lookup, in Table Two, of filter coefficients for the pixel that is to be interpolated. Address calculator 306 calculates an address for Table Two by using the inverse gradient values (unsigned, two-bit values) associated with P₋₁, P₀ and with P₁,P₂ as input. Address calculator 306 also uses filter phase information as input. FIG. 3B shows that, in one example, this phase information may be provided as an unsigned, five-bit value (“u5”). It is assumed in FIG. 3B that, in the example, a phase “s” is specified by the unsigned, five-bit value. Any number or type of phases may be provided within the filter phase information as input into the address calculator 306.

In one aspect, the unsigned, five-bit value of phase “s” may specify any one of thirty-two different phase values. In this aspect, it may be assumed that the distance between any two adjacent pixels in the original image (such as between pixels P₀ and P₁ in FIG. 2) may be equally divided into thirty-two sections. The continuous value x(i), defined above in equation (1), may then be represented by the nearest one of these thirty-two sections (i.e., the phase index). In this aspect, the thirty-two phases have indices from zero to thirty-one.

In one aspect, the phase may be derived from a status of a phase accumulator, which provides the value of phase “s” to address calculator 306. For example, the status of a phase accumulator associated with the Nth pixel in a horizontal dimension in the scaled image can be expressed as

temp64=Phase_init_{—}x+X_phase_stepsize*N (6),

and the phase “s” may be derived as

s=((temp64+2²⁴)>>24)−(((temp64+2²⁴)>>29)<<5) (7),

where X_phase_stepsize may be defined as

X_phase stepsize=(in_width<<29)/out_width (8),

where in_width specifies the input width in the horizontal dimension, and out_width specifies the output width in the horizontal dimension.

In the above equation (7), the constant value of “29” may be introduced to obtain a fixed-point representation of the corresponding floating number. Consequently, unit “1” may be represented by the constant “2²⁹”. In equation (7), the constant “2²⁴” may be used for rounding purposes. As for initial phase termPhase_init_x, there are several different methods that may be used to calculate it. In one aspect, it may be assumed that Phase_init_x is equal to zero.

Referring again to FIG. 3B, address calculator 306 provides an unsigned, nine-bit (“u9”) input as the address into Table Two (which is based upon each of the two-bit values for the inverse gradient values and the five-bit phase value). Filter coefficient lookup module 308 uses this address as input into Table Two to lookup corresponding edge-directed scaling filter coefficients, such as interpolation coefficients, that may be used to scale the image data 120. As shown in FIG. 3B, Table Two contains N entries, as will be described in further detail below. The edge-directed scaling filter coefficients, in the example of FIG. 3B, are represented in a signed, twelve-bit value as output from Table Two. These coefficients are then provided to filter 310 (FIG. 3A) for scaling purposes.

FIG. 3C is a block diagram illustrating an example of entries within a first lookup table that may be part of graphics device 100 shown in FIG. 3A (and which are also shown in FIG. 3B). Inverse gradient lookup module 304 is capable of processing these entries and performing a lookup of predetermined, quantized inverse gradient values. In FIG. 3C, this first lookup table is referred to as “TABLE 1” (Table One).

As stated above, in this example, Table One includes 2^{8-m} entries. Inverse gradient lookup module 304 performs a lookup of two predetermined inverse gradient values using the two quantized gradient values as input. One quantized gradient value is shown in FIG. 3C as “xl” (left), and the other is shown as “xr” (right). Each quantized gradient value is represented by an unsigned, (8-m) bit value. Inverse gradient lookup module 304 uses the quantized gradient value “xl” as input into Table One to perform a lookup of a predetermined inverse gradient value “yl,” and uses the quantized gradient value “xr” as input into Table One to perform a lookup of a predetermined inverse gradient value “yr.” Both “yl” and “yr” are represented in this example by a two-bit unsigned value, as is also shown in FIG. 3B.

In one aspect, Table One may be developed to substitute for the arithmetic operations involved in equations (2) and (3) shown previously (above). From equations (2) and (3), it can be observed that a direct implementation of them would contain square-root and inverse operations. These kinds of operations may not be favored by a hardware implementation within graphics device 100, in certain cases. As shown in FIG. 3C, the inputs of Table One are quantized gradient values “xl” and “xr”, and the outputs are corresponding inverse gradient values “yl” and “yr”. The size of Table One can be reduced by quantizing the input gradient values. In one aspect, parameter “m” may control the size of Table One. A smaller table typically requires less memory and takes less time for software to program.

In equation form, an inverse gradient value output of Table One can be expressed in terms of input as

$${y}_{l / r} = clamp ( ⌊ \frac{8 + 0.5}{\sqrt{1 + {2}^{m} α {x}_{l / r}}} ⌋ , 4 , 7 ) - 4 , \qquad ( 9 )$$

where 2^{m} is the quantization factor that is used to quantize the input gradient values. One can see that this equation is a fixed-point and clamped version of the original equations (2) and (3). Equation (9) can be evolved from equations (2) and (3) as follows. First, by expressing the gradient levels Δg_{l,/r} as their quantized versions 2^{m} x_{l/r}, equations (2) and (3) become

$${h}_{l / r} = \frac{1}{\sqrt{1 + {α2}^{m} {x}_{l / r}}} . \qquad ( 10 )$$

In one aspect, the range of h_{l/r} in equation (10) is [0, 1]. Then, if h_{l/r} is quantized with a factor of ⅛ and the results floored, equation (10) becomes

$${y}_{l / r} = ⌊ \frac{8 + 0.5}{\sqrt{1 + {α2}^{m} {x}_{l / r}}} ⌋ , \qquad ( 11 )$$

where y_{l/r} represents the quantized inverse gradient values, and the scalar 0.5 in equation (11) is used for rounding purposes. Lastly, a clamping operation “clamping (y_{l/r}, 4, 7)” may be performed. If y_{l/r}<4, y_{l/r} may be replaced by 4. If y_{l/r}>7, y_{l/r} may be replaced by 7.

Thus, in certain cases, y_{l/r} can have any integer values that are between 4 and 7 (inclusive). In addition, to save bits, it is possible to shift the range [4, 7] to [0, 3] by subtracting a scalar value of four from y_{l/r}, such that the final result is expressed in equation (9), according to one aspect.

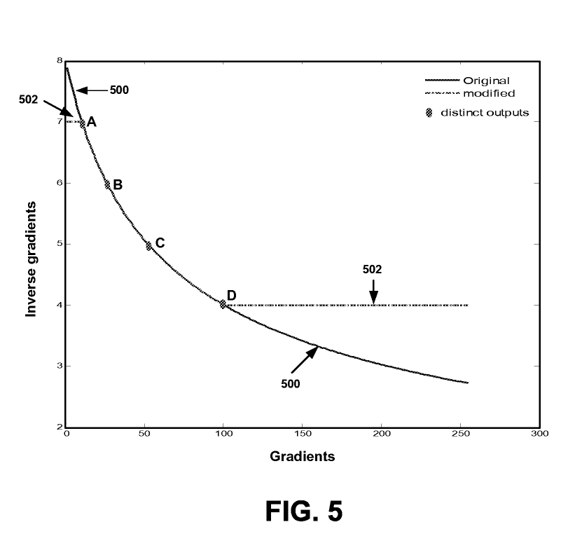

Based upon equation (9), in certain example scenarios, Table One's distinct outputs may correspond to integer values of 0, 1, 2, or 3. One potential objective of limiting the number of distinct outputs of Table One may be to reduce the size of Table Two (shown in FIGS. 3B and 3D), since Table One's outputs are among Table Two's inputs, subject to address calculation by address calculator 306. In one aspect, a significant reduction of Table One's distinct outputs results in negligible or no performance degradation of operation of graphics device 100. This may relate to certain benefits and advantages of using a dual lookup table (Table One, Table Two) design. In some cases, this may relate to the nonlinear property of the matching curve (equation (2)) and due to the fact that many gradient levels in a natural image distribute in a certain range, as is shown in FIG. 5 and described in more detail below. Consequently, reliable performance may be achieved in some scenarios without the need to make use of an entire range of gradient levels.

In one example scenario, with respect to FIG. 3C, it may be assumed that m=2. In this scenario, example input values “xl” and “xr” (quantized gradient values) for Table One, as well as corresponding example output values “yl” and “yr” (quantized inverse gradient values), are shown below in Table A. Because m=2, the input values range from [0-63], and because of the clamping operation, the output values range from [0-3]. For example, input values 0-3, 4-8, 9-15, and 16-63 may be mapped by Table One to output values 3, 2, 1, and 0, respectively. In this scenario, both the input values and output values are integer values.

TABLE A
Inputs and Outputs of Table One for m = 2

| Input Values | Output Values |
|---|---|
| (Quantized gradient | (Quantized inverse |
| values, x_{l/r)} | gradient values, y_{l/r)} |
| 0-3 | 3 |
| 4-8 | 2 |
| 9-15 | 1 |
| 16-63 | 0 |

FIG. 3D is a block diagram illustrating an example of an address calculator 306 and a second lookup table that may be part of graphics device 100 shown in FIG. 3A. In FIG. 3D, this second lookup table is referred to as “TABLE 2” (Table Two), and second lookup module 308 may perform the second table lookup within Table Two to obtain predetermined edge-directed scaling filter coefficients.

As is shown in the example of FIG. 3D, address calculator 306 generates an unsigned, nine-bit address using, as input, phase information (“Phase s”) and the output of Table One, as previously described with reference to FIG. 3B. The phase information includes an unsigned, five-bit value, and the output of Table One includes two inverse gradient values, each of which comprises an unsigned, two-bit value. The address generated by address calculator 306 is used by filter coefficient lookup module 308 to perform a lookup in Table Two of edge-directed scaling filter coefficients. In the example of FIG. 3D, these filter coefficients that may be used for upscaling, and they are represented by a signed, twelve-bit value. For example, if image scaling filter 310 is a four-tap filter, filter coefficient lookup module 308 may provide four coefficients, as output, to image scaling filter 310. If image scaling filter 310 is an eight-tap filter, filter coefficient lookup module 308 may provide eight coefficients, as output, to image scaling filter 310. Any number of coefficients may be provided as output from filter coefficient module 308.

In one aspect, as Table One may be used to replace the computations in equations (2) and (3) (shown previously above), Table Two may be built to replace the computations in equations (4) and (5). For example, a division operation is involved in equation (5), which may have high complexity for hardware implementation within graphics device 100. By using Table One to replace certain computations and Table Two to replace others, such that these tables contain predetermined (such as pre-calculated) values, the complexity for implementation within graphics device 100 may be significantly reduced.

In addition, by controlling the number of distinct outputs of Table One, the size of Table Two may be significantly reduced, to help minimize the size of table information 112 within storage medium 104. As noted previously, table information 112 may include both Table One and Table Two. In the example of FIG. 3D, the size of Table Two may be reduced to N=16 entries. In this example, because each of the two input inverse gradient values into Table Two comprise a two-bit value, N=4×4=16 entries, where the phase “Phase s” is represented by a separate five-bit input value into Table Two that specifies a phase within an entry.

In FIG. 3D, the outputs of Table Two are edge-directed scaling filter coefficients. In one aspect, the relation between inputs and outputs of Table Two may be provided as follows. First, the inverse gradient values hₗ/hᵣ are calculated according to equation (12), in which the y_{l/,r} represents the outputs of Table One.

$${h}_{l / r} = \{ \begin{matrix}\frac{{y}_{l / r} + 4}{8} & {h}_{l / r} < 3 \\ 1 & {h}_{l / r} = 3.\end{matrix} \qquad ( 12 )$$

With the obtained inverse gradient values, the scaling filter coefficients are calculated according to equation (5). The entries contained within Table Two may be predetermined (e.g., pre-calculated) and loaded into memory to form the contents of Table Two.

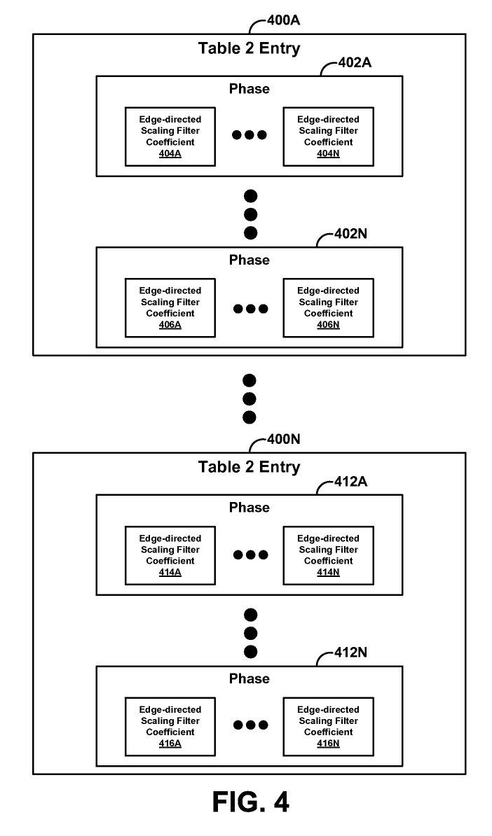

FIG. 4 is a block diagram illustrating an example of entries 400A-400N that may be included within a second lookup table, such as Table Two (“TABLE 2”) shown in FIG. 3D. FIG. 4 shows an example of one or more entries 400A-400N that are included within Table Two. In one aspect, the number of entries may be determined by the size of the quantized inverse gradient values provided as input into address calculator 306 (FIG. 3A). For example, if two quantized inverse gradient values are provided as input, and each inverse gradient value is a two-bit value, then Table Two may have sixteen entries (i.e., 4×4=16, where each two-bit value can represent up to 4 different values). In one aspect, the entry index for one of 400A-400N may be determined by ((yₗ<<2)+yᵣ), which may be determined by address calculator.

Each entry 400A-400N within Table Two contains one or more phases. For example, as shown in FIG. 4, entry 400A includes one or more phases 402A-402N, and entry 400N includes one or more phases 412A-412N. In one aspect, the number of phases for each entry may be determined by the size of the input phase information (such as the size of “Phase s” shown in FIG. 3D). For example, if the phase information is represented by a five-bit value, then each Table Two entry 400A-400N may include thirty two phases.

Address calculator 306 uses the quantized inverse gradient values and phase information to calculate an address of a specific phase within a given entry 400A-440N of Table Two. For example, in one scenario, address calculator 306 may generate an address that identifies phase 402A within entry 400A of Table Two, such that filter coefficient lookup module 308 may perform of lookup of edge-directed scaling filter coefficients 404A-404N associated with phase 402A. These edge-directed scaling filter coefficients may then be provided as output from Table Two (see, e.g., FIG. 3D) and used by filter 310 (FIG. 3A) to scale the image data.

Each phase 402A-402N in entry 400A contains a plurality of edge-directed scaling filter coefficients, and each phase 412A-412N in entry 400N contains a plurality of edge-directed scaling filter coefficients. Phase 402A includes filter coefficients 404A-404N; phase 402N includes filter coefficients 406A-406N; phase 412A includes filter coefficients 414A-414N; and phase 412N includes filter coefficients 416A-416N. These filter coefficients may be provided as output from Table Two. In one aspect, the number of filter coefficients associated with each phase may depend on the type of image scaling filter 310 that is used. For example, if image scaling filter 310 is a four-tap filter, then four filter coefficients for a phase may be provided as output from Table Two for use by image scaling filter 310 (where each tap is associated with one of the filter coefficients). If, however, image scaling filter 310 is an eight-tap filter, then eight filter coefficients for a phase may be provided as output. In one aspect, each of the values of the edge-directed scaling filter coefficients in entries 400A-400N (such as coefficients 404A-404N, 406A-406N, 414A-414N, and/or 416A-416N) may comprise a positive integer value, a negative integer value, or a value or zero. In other aspects, other values may be used for the filter coefficients.

In one example scenario, where Table Two includes sixteen entries, the order and indexing of these entries within Table Two, based upon the outputs of Table One, are shown below in Table B. In one aspect, address calculator 306 may calculate these indexes. Each index may then be associated with one of the entries within Table Two, such as, for example, one of entries 400A-400N.

TABLE B
Entry Indexes in Table Two

Outputs of Table One

| Inverse | Inverse | Entry Index |
|---|---|---|
| gradient value yₗ | gradient value yᵣ | for Table Two |
| 0 | 0 | 0 |
| 0 | 1 | 1 |
| 0 | 2 | 2 |
| 0 | 3 | 3 |
| 1 | 0 | 4 |
| 1 | 1 | 5 |
| 1 | 2 | 6 |
| 1 | 3 | 7 |
| 2 | 0 | 8 |
| 2 | 1 | 9 |
| 2 | 2 | 10 |
| 2 | 3 | 11 |
| 3 | 0 | 12 |
| 3 | 1 | 13 |
| 3 | 2 | 14 |
| 3 | 3 | 15 |

Thus, in one scenario, the calculation of the address by address calculator 306 of the scaling filter coefficients within Table Two may contains two parts. In the first part, the entry index is determined according to ((yₗ<<2)+yᵣ). This may determine the corresponding entry within Table Two, such as one of entries 400A-400N. Address calculator 306 may then determine the starting address of the scaling filter coefficients in the corresponding entry according to the phase (such as “Phase s” shown in FIG. 3D), such as one of phases 402A-402N if the entry corresponds to entry 400A.

In one example, the filter coefficients may be used for interpolation. For example, in reference to FIG. 2, four filter coefficients may be used by a four-tap filter (such as when image scaling filter 310, shown in FIG. 3A, is a four-tap filter) to interpolate the pixel at location Y The four filter coefficients may be applied to the respective values of pixels P₋₁, P₀, P₁, and P₂ to produce the interpolated pixel value. In other examples, however, different number of filter coefficients and source pixels may be used. For example, if image scaling filter 310 is an eight-tap filter, then eight filter coefficients may be used for interpolating a pixel. In this case, the eight coefficients may be applied to the eight respective pixel values P₋₃, P₋₂, P_{31 1}, P₀, P₁, P₂, P₃, and P₄ in the original image to produce the interpolated pixel value. These eight pixels to be used from the original image are determined according to determined procedures and to their respective locations, according to one aspect. In order to produce the interpolated pixel value, each filter coefficient may be multiplied by one of the pixels in the original image. The results of these multiplication operations may then summed in order to obtain a value of the pixel to be interpolated.

In one aspect, the filter coefficients may also be used for decimation. In this aspect, pixels in the original image are downscaled. In downscaling, the phase step is typically greater than one, where in upscaling, the phase step is typically less than one. The phase step may be defined for horizontal and vertical dimensions respectively. For the horizontal dimension, it may be defined as (input_width/output_width), and in the vertical dimension, it may be defined as (input_height/output_height). The various techniques described above with respect to scaling may be applied to both upscaling and downscaling operations, where the phase step for downscaling may often be greater than one.

FIG. 5 is a graph diagram illustrating gradient and inverse gradient values, according to one aspect of the disclosure. In FIG. 5, example gradient values are shown along the horizontal axis (x-axis), and example inverse gradient values are shown along the vertical axis (y-axis).

As described previously, one objective of limiting the number of distinct outputs of Table One may be to reduce the size of Table Two, given that Table One's outputs are among Table Two's inputs. In one aspect, a significant reduction of Table One's distinct outputs (for quantized inverse gradient values) results in negligible or no performance degradation of operation of graphics device 100. This may be partially due to the nonlinear property of the matching curve (equation (2)), and may also be partially due to the fact that many gradient levels in a natural image tend to distribute in a certain range. For example, gradient values that are larger than one hundred are generally rare in a natural image.

In FIG. 5, an original matching curve 500 (from equation (2), associated with original inverse gradient values), along with a modified matching curve 502 (from equation (11), associated with quantized inverse gradient values), are shown. The original matching curve 500 is shown using a solid line, and the modified curve 502 is shown using dashed-dotted line. In addition, FIG. 5 shows four distinct points A, B, C, and D, which correspond to four quantized inverse gradient values of 7, 6, 5, and 4 that may be output by Table One. As described previously, a clamping operation may be performed on the results of equation (11), such that y_{l/r} can have any integer values that are between 4 and 7 (inclusive).

In FIG. 5, it can be seen that the modified curve overlaps 502 with the original matching curve 500 in the range of gradient values between [16, 100]. In many cases, this range of gradient values covers most structure-representing gradient levels in a natural image. Thus, in these cases, inverse gradient values range between [4, 7]. Because clamping is performed, the inverse gradient values of the modified curve 502 are quantized to distinct integer values in the range [4, 7], corresponding to points D, C, B, and A, respectively, in FIG. 5. Any inverse gradient values in the modified curve 502 greater than seven are set equal to seven, and any inverse gradient values less than four are set equal to four.

Because, in many cases, gradient values larger than one hundred are generally rare in a natural image, and because a range of values between [16, 100] often covers most structure-representing gradient levels in a natural image, quantization of both gradient values and inverse gradient values can be performed while maintaining the sharpness of the scaled image. In addition, through use of quantization, and use of two lookup tables (Table One and Table Two), an edge-directed scaling technique may be implemented within graphics device 100 without requiring the complexity of complicated algorithms or calculations that may otherwise need to be performed by graphics device 100.

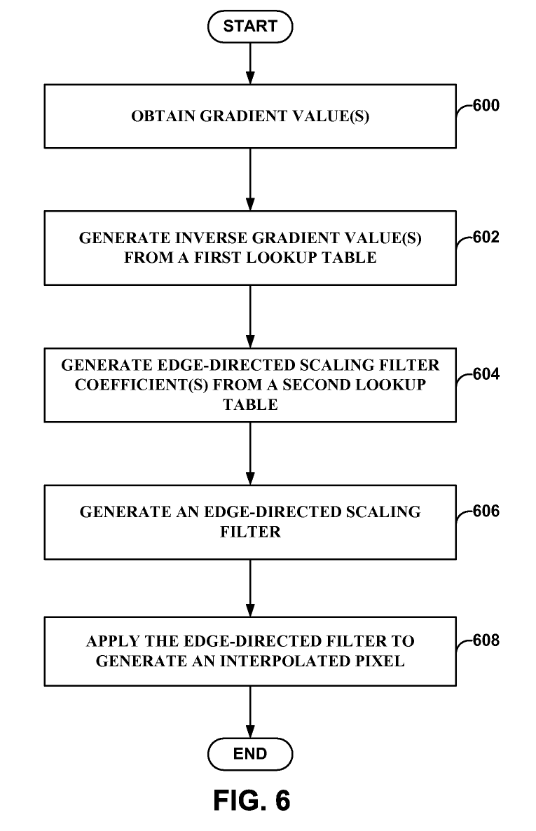

FIG. 6 is a flow diagram illustrating a method that may be performed by graphics device 100 (FIGS. 1 and 3A) to generate scaling filter coefficients that may be used to scale image data 120 (FIG. 1), according to one aspect of the disclosure. In this aspect, graphics device 100 may perform acts 600, 602, 604, 606, and 608 to generate upscaled or downscaled image data 122 from image data 120.

At 600, gradient quantization module 302 (FIG. 3A) obtains one or more gradient values used for scaling of image data 120, where each gradient value indicates a gradient between values of at least two pixels of image data 120 in a source image. Gradient values calculator 300 may calculate the one or more gradient values and provide these values to gradient quantization module 302 for processing.

At 602 of FIG. 6, inverse gradient lookup module 304 may generate one or more predetermined (such as pre-calculated) inverse gradient values from a first lookup table (Table One) based on the one or more gradient values. The gradient values may be used as indices into Table One when performing a lookup. Inverse gradient look module 304 may then provide the inverse gradient values to address calculator 306. In certain scenarios, gradient quantization module 302 may perform a non-uniform quantization of the one or more gradient values to obtain one or more quantized gradient values. Inverse gradient lookup module 304 may also perform a lookup in Table One of predetermined, quantized inverse gradient values based on the one or more quantized gradient values. Address calculator 306 may then use the quantized inverse gradient values that are provided as output from Table One.

In one aspect, the one or more quantized inverse gradient values that are stored in Table One comprise predetermined values. In some cases, these predetermined inverse gradient values are calculated and pre-stored in Table One based upon one or more non-uniform quantization algorithms. The one or more non-uniform quantization algorithms may include one or more clamping functions, as was described previously.

At 604 of FIG. 6, filter coefficient lookup module 308 (FIG. 3A) may generate one or more predetermined edge-directed scaling filter coefficients from a second lookup table (Table Two) based upon the one or more inverse gradient values (which may comprise quantized inverse gradient values). The one or more predetermined edge-directed scaling filters may comprise one or more pre-calculated edge-directed scaling filters.

In one aspect, filter coefficient lookup module 308 and address calculator 306 may generate the one or more predetermined edge-directed scaling filter coefficients from Table Two based on the one or more inverse gradient values and also phase information. FIG. 3D shows an example of such a scenario in which phase information for “Phase s” is used as input to address calculator 306. The phase information may at least partially indicate a position of a pixel that is to be interpolated with respect to the at least two pixels in the source image.

At 606 of FIG. 6, image scaling filter 310 (FIG. 3A) may generate an edge-directed scaling filter based on the one or more edge-directed scaling filter coefficients. At 608, image scaling filter 310 may then apply the edge-directed scaling filter to the at least two pixels of the source image to generate an interpolated pixel in a scaled image (such as an upscaled or downscaled image), which may then be displayed on a display device (such as display device 106 shown in FIG. 1).

In one aspect, graphics device 100 repeats the obtaining of the one or more gradient values (600), generating the one or more inverse gradient values (602), and generating the one or more edge-directed scaling filter coefficients (604) for a plurality of pixels from image data 120 in the source image in order to generate a plurality of interpolated pixels in scaled image data 122 of the scaled image. Device may also repeat the generating of an edge-directed filter (606) and applying the edge-directed filter (608) during this process.

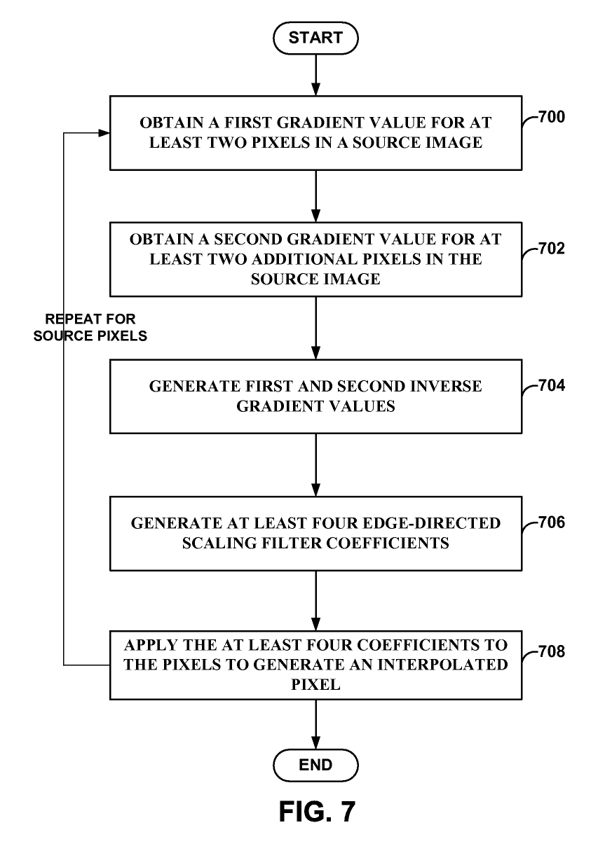

FIG. 7 is a flow diagram illustrating a method that may be performed by graphics device 100 (FIGS. 1 and 3A) to generate a plurality of interpolated pixels, according to one aspect of the disclosure. In this aspect, graphics device 100 may perform acts 700, 702, 704, 706, and 708 to generate scaled image data 122 from source image data 120.

At 700, gradient quantization module 302 (FIG. 3A) may obtain a first gradient value indicating a first gradient between values of at least two pixels of image data 120 in a source image. These at least two pixels may be located on a first side (such as a left side) of a pixel that is to be interpolated in scaled image data 122 of a scaled image. For example, with reference to FIG. 2, the first gradient value may be associated with pixels P₋₁ and P₀ (for a pixel at location Y that is to be interpolated).

At 702 of FIG. 7, gradient quantization module 302 may obtain a second gradient value indicating a second gradient between values of at least two additional pixels of image data 120 in the source image. These at least two additional pixels may be located on a second, different side (such as a right side) of the pixel that is to be interpolated in scaled image data 122. For example, with reference to FIG. 2, the second gradient value may be associated with pixels P₁ and P₂ (for the pixel at location Y that is to be interpolated). Gradient values calculator 300 may calculate these first and second gradient values, which may also then be quantized by gradient quantization module 302.

At 704 of FIG. 7, inverse gradient lookup module 304 (FIG. 3A) is capable of generating a first inverse gradient value from a first lookup table (Table One) based on the first gradient value obtained at 700. Inverse gradient lookup module 304 is further capable of generating a second inverse gradient value from Table One based on the second gradient value obtained at 702.

At 706, filter coefficient lookup module 308 (FIG. 3A) is capable of generating at least four edge-directed scaling filter coefficients from a second lookup table (Table Two) based on the first and second inverse gradient values generated at 704. Address calculator 306 may use the generated first and second inverse gradient values to calculate a lookup address in Table Two for use by filter coefficient lookup module 308 in generating the at least four filter coefficients.

At 708, image scaling filter 310 (FIG. 3A) may apply the at least four edge-directed scaling filter coefficients to the at least two pixels and the at least two additional pixels (source pixels) in the source image to generate an interpolated pixel in the scaled image. In one aspect, each filter coefficient corresponds to a weighting factor. Image scaling filter 310 may multiply each filter coefficient by one of the source pixels in the source image. For example, if the source pixels in the source image correspond to pixels P₋₁, P₀, P₁, and P₂ shown in FIG. 2, for example, a first generated filter coefficient may be multiplied by the magnitude of P₋₁, a second generated filter coefficient may be multiplied by the magnitude of P₀, a third generated filter coefficient may be multiplied by the magnitude of P₁, and a fourth generated filter coefficient may be multiplied by the magnitude of P₂. The results of these multiplication operations may then be summed together and normalized to complete the filtering and generate the magnitude of the interpolated pixel at location Y. In one aspect, the sum of each of the generated filter coefficients is equal to one.

After image scaling filter 310 has generated the interpolated pixel, graphics device 100 may repeat 700, 702, 704, 706, and 708 to apply generated edge-directed scaling filter coefficients, in a repeated fashion, to a plurality of source pixels in the source image in a horizontal and/or a vertical direction to generate interpolated pixels of the scaled image. A “sliding window” may be used to repeatedly apply filter coefficients to source pixels in the source image when generating the interpolated pixels, such that one individual filter coefficient is applied to an individual source pixel within the “sliding window”. The “sliding window” may contain multiple source pixels, and may first be moved in a horizontal direction (left-to-right) across pixels within a row of the source image. The “sliding window” may also be moved in a vertical direction (up-down) to slide across the various pixels in the source image. As the “sliding window” moves, generated filter coefficients may then be applied to the source pixels within the “sliding window”. In such fashion, the entire source image may be scaled by generating a plurality of interpolated pixels for a scaled image.

The implementation of a dual lookup table design, such as by using a first lookup table that stores predetermined inverse gradient values and a second lookup table that stored predetermined edge-directed scaling filters, may provide various benefits and advantages. For example, a dual lookup table design may help minimize or avoid the use complex computations and arithmetic operations within graphics device 100. Thus, the hardware complexity for certain scaling functionality within graphics device 100 may be minimized. In addition, the use of quantization, such as non-uniform quantization, may help reduce the size of the lookup tables, while still maintaining the performance an edge-directed scaling algorithm. Quantized gradient values may serve as input into the first lookup table, which may then provide, as output, quantized inverse gradient values. These quantized inverse gradient values may then serve as input into the second lookup table. Because the inverse gradient values are quantized, the size of the second lookup table can be significantly decreased.

The techniques described in this disclosure may be implemented within a general purpose microprocessor, digital signal processor (DSP), application specific integrated circuit (ASIC), field programmable gate array (FPGA), or other equivalent logic devices. Accordingly, the terms “processor” or “controller,” as used herein, may refer to any of the foregoing structures or any other structure suitable for implementation of the techniques described herein.

The various components illustrated herein may be realized by any suitable combination of hardware, software, firmware, or any combination thereof. In the figures, various components are depicted as separate units or modules. However, all or several of the various components described with reference to these figures may be integrated into combined units or modules within common hardware and/or software. Accordingly, the representation of features as components, units or modules is intended to highlight particular functional features for ease of illustration, and does not necessarily require realization of such features by separate hardware or software components. In some cases, various units may be implemented as programmable processes performed by one or more processors.

Any features described herein as modules, devices, or components, including graphics device 100 and/or its constituent components, may be implemented together in an integrated logic device or separately as discrete but interoperable logic devices. In various aspects, such components may be formed at least in part as one or more integrated circuit devices, which may be referred to collectively as an integrated circuit device, such as an integrated circuit chip or chipset. Such circuitry may be provided in a single integrated circuit chip device or in multiple, interoperable integrated circuit chip devices, and may be used in any of a variety of image, display, audio, or other multi-media applications and devices. In some aspects, for example, such components may form part of a mobile device, such as a wireless communication device handset.

If implemented in software, the techniques may be realized at least in part by a computer-readable medium comprising code with instructions that, when executed by one or more processors, performs one or more of the methods described above. The computer-readable medium may form part of a computer program product, which may include packaging materials. The computer-readable medium may comprise random access memory (RAM) such as synchronous dynamic random access memory (SDRAM), read-only memory (ROM), non-volatile random access memory (NVRAM), electrically erasable programmable read-only memory (EEPROM), embedded dynamic random access memory (eDRAM), static random access memory (SRAM), flash memory, magnetic or optical data storage media.

The techniques additionally, or alternatively, may be realized at least in part by a computer-readable communication medium that carries or communicates code in the form of instructions or data structures and that can be accessed, read, and/or executed by one or more processors. Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media. Any software that is utilized may be executed by one or more processors, such as one or more DSP's, general purpose microprocessors, ASIC's, FPGA's, or other equivalent integrated or discrete logic circuitry.

Various aspects of the disclosure have been described. These and other aspects are within the scope of the following claims.

1. A method comprising: obtaining one or more gradient values that each indicates a gradient between values of at least two pixels in a source image; generating one or more inverse gradient values from a first lookup table based on the one or more gradient values; and generating one or more edge-directed scaling filter coefficients from a second lookup table based on the one or more inverse gradient values.

2. The method of claim 1, further comprising: generating an edge-directed scaling filter based on the one or more edge-directed scaling filter coefficients.

3. The method of claim 2, further comprising: applying the edge-directed scaling filter to the at least two pixels in the source image to generate an interpolated pixel in a scaled image; and displaying the interpolated pixel of the scaled image on a display device, wherein the scaled image comprises one of an upscaled image or a downscaled image.

4. The method of claim 1, wherein: the one or more inverse gradient values comprise one or more pre-calculated inverse gradient values; and the one or more edge-directed scaling filter coefficients comprise one or more pre-calculated edge-directed scaling filter coefficients.

5. The method of claim 1, wherein obtaining the one or more gradient values comprises: obtaining a first gradient value indicating a first gradient between values of the at least two pixels in the source image that are located on a first side of a pixel to be interpolated in a scaled image; and obtaining a second gradient value indicating a second gradient between values of at least two additional pixels in the source image that are located on a second, different side of the pixel to be interpolated in the scaled image, and wherein generating the one or more inverse gradient values comprises: generating a first inverse gradient value from the first lookup table based on the first gradient value; and generating a second inverse gradient value from the first lookup table based on the second gradient value.

6. The method of claim 5, wherein generating the one or more edge-directed scaling filter coefficients from the second lookup table comprises generating at least four edge-directed scaling filter coefficients from the second lookup table based on the first and second inverse gradient values.

7. The method of claim 6, further comprising: applying the at least four edge-directed scaling filter coefficients to the at least two pixels and to the at least two additional pixels to generate an interpolated pixel.

8. The method of claim 1, further comprising performing a non-uniform quantization of the one or more gradient values to obtain one or more quantized gradient values, and wherein generating the one or more inverse gradient values comprises generating the one or more inverse gradient values from the first lookup table based on the one or more quantized gradient values.

9. The method of claim 1, wherein: generating the one or more inverse gradient values comprises generating one or more quantized inverse gradient values from the first lookup table based on the one or more gradient values; generating the one or more edge-directed scaling filter coefficients comprises generating the one or more edge-directed scaling filter coefficients from the second lookup table based on the one or more quantized inverse gradient values; and the one or more quantized inverse gradient values comprise predetermined values that are calculated from one or more non-uniform quantization algorithms.

10. The method of claim 9, wherein the one or more non-uniform quantization algorithms comprise one or more clamping functions.

11. The method of claim 1, further comprising receiving phase information that at least partially indicates a position of a pixel to be interpolated with respect to the at least two pixels in the source image, and wherein generating the one or more edge-directed scaling filter coefficients comprises generating the one or more edge-directed scaling filter coefficients based on the one or more inverse gradient values and the phase information.

12. The method of claim 1, further comprising: repeating the obtaining of the one or more gradient values, the generating of the one or more inverse gradient values, and the generating of the one or more edge-directed scaling filter coefficients for a plurality of pixels in the source image to generate a plurality of interpolated pixels in a scaled image, wherein the repeating further comprises applying the generated edge-directed scaling filter coefficients, in a repeated fashion, to the plurality of pixels in the source image in a horizontal or a vertical direction to generate the interpolated pixels of the scaled image.

13. A device comprising: a storage medium configured to store a first lookup table and a second lookup table; and one or more processors configured to obtain one or more gradient values that each indicates a gradient between values of at least two pixels in a source image, generate one or more inverse gradient values from the first lookup table based on the one or more gradient values, and generate one or more edge-directed scaling filter coefficients from the second lookup table based on the one or more inverse gradient values.

14. The device of claim 13, wherein the one or more processors are further configured to generate an edge-directed scaling filter based on the one or more edge-directed scaling filter coefficients.

15. The device of claim 14, further comprising a display device, and wherein: the one or more processors are further configured to apply the edge-directed scaling filter to the at least two pixels in the source image to generate an interpolated pixel in a scaled image; the display device is configured to display the interpolated pixel of the scaled image; the scaled image comprises one of an upscaled image or a downscaled image; and each of the one or more processors comprises a display processor, a graphics processor, or a control processor.

16. The device of claim 13, wherein: the one or more inverse gradient values comprise one or more pre-calculated inverse gradient values; and the one or more edge-directed scaling filter coefficients comprise one or more pre-calculated edge-directed scaling filter coefficients.

17. The device of claim 13, wherein: the one or more processors are configured to obtain the one or more gradient values at least in part by obtaining a first gradient value indicating a first gradient between values of the at least two pixels in the source image that are located on a first side of a pixel to be interpolated in a scaled image, and by obtaining a second gradient value indicating a second gradient between values of at least two additional pixels in the source image that are located on a second, different side of the pixel to be interpolated in the scaled image; and the one or more processors are configured to generate the one or more inverse gradient values at least in part by generating a first inverse gradient value from the first lookup table based on the first gradient value, and generating a second inverse gradient value from the first lookup table based on the second gradient value.

18. The device of claim 17, wherein the one or more processors are configured to generate the one or more edge-directed scaling filter coefficients from the second lookup table at least in part by generating at least four edge-directed scaling filter coefficients from the second lookup table based on the first and second inverse gradient values.

19. The device of claim 18, wherein the one or more processors are further configured to apply the at least four edge-directed scaling filter coefficients to the at least two pixels and to the at least two additional pixels to generate an interpolated pixel.

20. The device of claim 13, wherein the one or more processors are further configured to perform a non-uniform quantization of the one or more gradient values to obtain one or more quantized gradient values, and wherein the one or more processors are configured to generate the one or more inverse gradient values at least in part by generating the one or more inverse gradient values from the first lookup table based on the one or more quantized gradient values.

21. The device of claim 13, wherein: the one or more processors are configured to generate the one or more inverse gradient values at least in part by generating one or more quantized inverse gradient values from the first lookup table based on the one or more gradient values; the one or more processors are configured to generate the one or more edge-directed scaling filter coefficients at least in part by generating the one or more edge-directed scaling filter coefficients from the second lookup table based on the one or more quantized inverse gradient values; and the one or more quantized inverse gradient values comprise predetermined values that are calculated from one or more non-uniform quantization algorithms.

22. The device of claim 21, wherein the one or more non-uniform quantization algorithms comprise one or more clamping functions.

23. The device of claim 13, wherein the one or more processors are further configured to receive phase information that at least partially indicates a position of a pixel to be interpolated with respect to the at least two pixels in the source image, and wherein the one or more processors are configured to generate the one or more edge-directed scaling filter coefficients at least in part by generating the one or more edge-directed scaling filter coefficients based on the one or more inverse gradient values and the phase information.

24. The device of claim 13, wherein: the one or more processors are further configured to repeat obtaining the one or more gradient values, generating the one or more inverse gradient values, and generating the one or more edge-directed scaling filter coefficients for a plurality of pixels in the source image to generate a plurality of interpolated pixels in a scaled image; and the one or more processors are further configured to apply the generated edge-directed scaling filter coefficients, in a repeated fashion, to the plurality of pixels in the source image in a horizontal or a vertical direction to generate the interpolated pixels of the scaled image.

25. The device of claim 13, wherein the device comprises a wireless communication device handset.

26. The device of claim 13, wherein the device comprises one or more integrated circuit devices.

27. A device comprising: means for obtaining one or more gradient values that each indicates a gradient between values of at least two pixels in a source image; means for generating one or more inverse gradient values from a first lookup table based on the one or more gradient values; and means for generating one or more edge-directed scaling filter coefficients from a second lookup table based on the one or more inverse gradient values.

28. The device of claim 27, further comprising: means for generating an edge-directed scaling filter based on the one or more edge-directed scaling filter coefficients.

29. The device of claim 28, further comprising: means for applying the edge-directed scaling filter to the at least two pixels in the source image to generate an interpolated pixel in a scaled image; and means for displaying the interpolated pixel of the scaled image on a display device, wherein the scaled image comprises one of an upscaled image or a downscaled image.

30. The device of claim 27, wherein: the one or more inverse gradient values comprise one or more pre-calculated inverse gradient values; and the one or more edge-directed scaling filter coefficients comprise one or more pre-calculated edge-directed scaling filter coefficients.

31. The device of claim 27, wherein the means for obtaining the one or more gradient values comprises: means for obtaining a first gradient value indicating a first gradient between values of the at least two pixels in the source image that are located on a first side of a pixel to be interpolated in a scaled image; and means for obtaining a second gradient value indicating a second gradient between values of at least two additional pixels in the source image that are located on a second, different side of the pixel to be interpolated in the scaled image, and wherein the means for generating the one or more inverse gradient values comprises: means for generating a first inverse gradient value from the first lookup table based on the first gradient value; and means for generating a second inverse gradient value from the first lookup table based on the second gradient value.

32. The device of claim 31, wherein the means for generating the one or more edge-directed scaling filter coefficients from the second lookup table comprises means for generating at least four edge-directed scaling filter coefficients from the second lookup table based on the first and second inverse gradient values.

33. The device of claim 32, further comprising: means for applying the at least four edge-directed scaling filter coefficients to the at least two pixels and to the at least two additional pixels to generate an interpolated pixel.

34. The device of claim 27, further comprising means for performing a non-uniform quantization of the one or more gradient values to obtain one or more quantized gradient values, and wherein the means for generating the one or more inverse gradient values comprises means for generating the one or more inverse gradient values from the first lookup table based on the one or more quantized gradient values.

35. The device of claim 27, wherein: the means for generating the one or more inverse gradient values comprises means for generating one or more quantized inverse gradient values from the first lookup table based on the one or more gradient values; the means for generating the one or more edge-directed scaling filter coefficients comprises means for generating the one or more edge-directed scaling filter coefficients from the second lookup table based on the one or more quantized inverse gradient values; and the one or more quantized inverse gradient values comprise predetermined values that are calculated from one or more non-uniform quantization algorithms.

36. The device of claim 35, wherein the one or more non-uniform quantization algorithms comprise one or more clamping functions.

37. The device of claim 27, further comprising means for receiving phase information that at least partially indicates a position of a pixel to be interpolated with respect to the at least two pixels in the source image, and wherein the means for generating the one or more edge-directed scaling filter coefficients comprises means for generating the one or more edge-directed scaling filter coefficients based on the one or more inverse gradient values and the phase information.

38. The device of claim 27, further comprising: means for repeating the obtaining of the one or more gradient values, the generating of the one or more inverse gradient values, and the generating of the one or more edge-directed scaling filter coefficients for a plurality of pixels in the source image to generate a plurality of interpolated pixels in a scaled image, wherein the means for repeating comprises means for applying the generated edge-directed scaling filter coefficients, in a repeated fashion, to the plurality of pixels in the source image in a horizontal or a vertical direction to generate the interpolated pixels of the scaled image.

39. A computer-readable medium comprising instructions for causing one or more processors to obtain one or more gradient values that each indicates a gradient between values of at least two pixels in a source image; generate one or more inverse gradient values from a first lookup table based on the one or more gradient values; and generate one or more edge-directed scaling filter coefficients from a second lookup table based on the one or more inverse gradient values.

40. The computer-readable medium of claim 39, further comprising instructions for causing the one or more processors to: generate an edge-directed scaling filter based on the one or more edge-directed scaling filter coefficients.

41. The computer-readable medium of claim 40, further comprising instructions for causing the one or more processors to: apply the edge-directed scaling filter to the at least two pixels in the source image to generate an interpolated pixel in a scaled image; and display the interpolated pixel of the scaled image on a display device, wherein the scaled image comprises one of an upscaled image or a downscaled image.

42. The computer-readable medium of claim 39, wherein: the one or more inverse gradient values comprise one or more pre-calculated inverse gradient values; and the one or more edge-directed scaling filter coefficients comprise one or more pre-calculated edge-directed scaling filter coefficients.

43. The computer-readable medium of claim 39, wherein: the instructions for causing the one or more processors to obtain the one or more gradient values comprise instructions for causing the one or more processors to obtain a first gradient value indicating a first gradient between values of the at least two pixels in the source image that are located on a first side of a pixel to be interpolated in a scaled image, and to obtain a second gradient value indicating a second gradient between values of at least two additional pixels in the source image that are located on a second, different side of the pixel to be interpolated in the scaled image; and the instructions for causing the one or more processors to generate the one or more inverse gradient values comprise instructions for causing the one or more processors to generate a first inverse gradient value from the first lookup table based on the first gradient value, and to generate a second inverse gradient value from the first lookup table based on the second gradient value.

44. The computer-readable medium of claim 43, wherein the instructions for causing the one or more processors to generate the one or more edge-directed scaling filter coefficients from the second lookup table comprise instructions for causing the one or more processors to generate at least four edge-directed scaling filter coefficients from the second lookup table based on the first and second inverse gradient values.

45. The computer-readable medium of claim 44, further comprising instructions for causing the one or more processors to apply the at least four edge-directed scaling filter coefficients to the at least two pixels and to the at least two additional pixels to generate an interpolated pixel.

46. The computer-readable medium of claim 39, further comprising instructions for causing the one or more processors to perform a non-uniform quantization of the one or more gradient values to obtain one or more quantized gradient values, and wherein the instructions for causing the one or more processors to generate the one or more inverse gradient values comprise instructions for causing the one or more processors to generate the one or more inverse gradient values from the first lookup table based on the one or more quantized gradient values.

47. The computer-readable medium of claim 39, wherein: the instructions for causing the one or more processors to generate the one or more inverse gradient values comprise instructions for causing the one or more processors to generate one or more quantized inverse gradient values from the first lookup table based on the one or more gradient values; the instructions for causing the one or more processors to generate the one or more edge-directed scaling filter coefficients comprise instructions for causing the one or more processors to generate the one or more edge-directed scaling filter coefficients from the second lookup table based on the one or more quantized inverse gradient values; and the one or more quantized inverse gradient values comprise predetermined values that are calculated from one or more non-uniform quantization algorithms.

48. The computer-readable medium of claim 47, wherein the one or more non-uniform quantization algorithms comprise one or more clamping functions.

49. The computer-readable medium of claim 39, further comprising instructions for causing the one or more processors to receive phase information that at least partially indicates a position of a pixel to be interpolated with respect to the at least two pixels in the source image, and wherein the instructions for causing the one or more processors to generate the one or more edge-directed scaling filter coefficients comprise instructions for causing the one or more processors to generate the one or more edge-directed scaling filter coefficients based on the one or more inverse gradient values and the phase information.

50. The computer-readable medium of claim 39, further comprising instructions for causing the one or more processors to repeat the obtaining of the one or more gradient values, the generating of the one or more inverse gradient values, and the generating of the one or more edge-directed scaling filter coefficients for a plurality of pixels in the source image to generate a plurality of interpolated pixels in a scaled image, wherein the instructions for causing the one or more processors to repeat further comprise instructions for causing the one or more processors to apply the generated edge-directed scaling filter coefficients, in a repeated fashion, to the plurality of pixels in the source image in a horizontal or a vertical direction to generate the interpolated pixels of the scaled image.
